(19) United States
(12) Patent Application Publication
(10) Pub. No.: US 2025/0296109 A1
(43) Pub. Date: Sep. 25, 2025

(54) SYSTEM AND APPARATUS FOR WATER FLOW AND VORTEX FORMATION

(71) Applicants: Thomas Mark Fleischer, South Weber, UT (US); Karlie M. Fleischer, South Weber, UT (US)

(72) Inventors: Thomas Mark Fleischer, South Weber, UT (US); Karlie M. Fleischer, South Weber, UT (US)

(21) Appl. No.: 18/609,759

(22) Filed: Mar. 19, 2024

(51) Int. Cl. B05B 17/08; B05B 1/34

(52) U.S. Cl. CPC B05B 17/08; B05B 1/3405

(57) ABSTRACT

Examples of the present disclosure include an apparatus. The apparatus includes a plate with a number of apertures extending from a first side of the plate to a second side of the plate opposite to the first side. The number of apertures include a first aperture and a subset of apertures. The apparatus includes a tubular member fixedly coupled to the second side of the plate at a first tubular member end. The tubular member has a perimeter surrounded by the subset of apertures and surrounding the first aperture. The apparatus includes a first nozzle and a second nozzle. The apparatus includes a number of pipes and a pump configured to pump water through a pipe of the number of pipes and out of at least one of the first nozzle and the second nozzle.

### FIELD

This disclosure relates generally to water flow, and more particularly to systems and apparatuses for water flow and vortex formation.

### BACKGROUND

Decorative water features can enhance the visual and audio appeal of indoor and outdoor spaces. Fountains and other water features can offer a calming effect with visual and/or sound effects. External forces can be used to manipulate fluid velocity and thus form and maintain a water vortex.

### SUMMARY

The subject matter of the present application has been developed in response to the present state of the art, and in particular, in response to the shortcomings of water flow and vortex formation that have not yet been fully solved by currently available techniques. Accordingly, the subject matter of the present application has been developed to provide systems and apparatuses for water flow and vortex formation that overcome at least some of the above-discussed shortcomings of prior art techniques.

The following is a non-exhaustive list of examples, which may or may not be claimed, of the subject matter, disclosed herein.

The following portion of this paragraph delineates example 1 of the subject matter, disclosed herein. According to example 1, an apparatus includes a plate. The plate includes a number of apertures extending from a first side of the plate to a second side of the plate opposite to the first side. The number of apertures includes a first aperture and a subset of apertures. The apparatus includes a tubular member fixedly coupled to the second side of the plate at a first tubular member end. The tubular member has a perimeter surrounded by the subset of apertures and surrounding the first aperture. The apparatus includes a first nozzle. The first nozzle includes a first first-nozzle portion coupled to the second side of the plate at a first location and extending into the tubular member in a first direction substantially perpendicular to the plate and a second first-nozzle portion extending, from a first end coupled to the first first-nozzle portion to a second end opposite to the first end, in a second direction substantially perpendicular to the first direction. The apparatus includes a second nozzle. The second nozzle includes a first second-nozzle portion coupled to the second side of the plate at a second location and extending into the tubular member in a third direction substantially parallel to the first direction and a second second-nozzle portion extending, from a first end coupled to the first second-nozzle portion to a second end opposite to the first end, in a fourth direction substantially opposite to the second direction and substantially perpendicular to the third direction. The apparatus includes a number of pipes. The apparatus includes a water pump coupled to the number of pipes and configured to pump water through a pipe of the number of pipes and out of at least one of the first nozzle and the second nozzle.

The following portion of this paragraph delineates example 2 of the subject matter, disclosed herein. According to example 2, which encompasses example 1, above, each aperture of the subset of apertures has a width such that a maximum width of the first aperture is not less than thirty percent of a width of each aperture of the subset of apertures and not greater than sixty percent of the width of each aperture of the subset of apertures.

The following portion of this paragraph delineates example 3 of the subject matter, disclosed herein. According to example 3, which encompasses example 1 or 2, above, the tubular member has a maximum width, in a direction substantially parallel to the plate, such that the maximum width of the first aperture is not less than 5 percent of the maximum width of the tubular member and not greater than 13 percent of the maximum width of the tubular member.

The following portion of this paragraph delineates example 4 of the subject matter, disclosed herein. According to example 4, which encompasses any one of examples 1-3, above, a distance between each of the second location and the first aperture and the first location and the first aperture is less than 50 percent of the maximum width of the tubular member and not less than 35 percent of the maximum width of the tubular member.

The following portion of this paragraph delineates example 5 of the subject matter, disclosed herein. According to example 5, which encompasses any one of examples 1-4, above, the pump is configured to pump the water at an hourly rate of not less than a product of 215 and a water volume of the tubular member and not greater than a product of 430 and a water volume of the tubular member.

The following portion of this paragraph delineates example 6 of the subject matter, disclosed herein. According to example 6, which encompasses any one of examples 1-5, above, the water volume is a product of a volume of the tubular member, in cubic meters, and 264.172 gallons.

The following portion of this paragraph delineates example 7 of the subject matter, disclosed herein. According to example 7, which encompasses any one of examples 1-6, above, the number of pipes include a first pipe. The first pipe includes a first first-pipe end coupled to the first first-nozzle portion and a second first-pipe end opposite to the first first-pipe end. The number pipes includes a second pipe. The second pipe includes a first second-pipe end coupled to the first second-nozzle portion and a second second-pipe end opposite to the first second-pipe end. The number of pipes includes a third pipe. The third pipe includes a first third-pipe end and a second third-pipe end. The pipe includes the third pipe.

The following portion of this paragraph delineates example 8 of the subject matter, disclosed herein. According to example 8, which encompasses any one of examples 1-7, above, the apparatus includes a coupler. The coupler is configured to couple the third pipe to the first pipe and the second pipe. The coupler includes a first coupler portion coupled to the second first-pipe end. The coupler includes a second coupler portion coupled to the second second-pipe end and extending at a first angle with respect to the first coupler portion. The coupler includes a third coupler portion coupled to the first third-pipe end. The third coupler portion extends at a second angle with respect to the second coupler portion and extending at a third angle with respect to the first coupler portion.

The following portion of this paragraph delineates example 9 of the subject matter, disclosed herein. According to example 9, which encompasses any one of examples 1-8, above, the first angle is not less than 90 degrees and not greater than 130 degrees. The second angle is not less than 90 degrees and not greater than 130 degrees. The third angle is not more than 5 degrees greater than and not more than 5 degrees less than the second angle.

The following portion of this paragraph delineates example 10 of the subject matter, disclosed herein. According to example 10, which encompasses any one of examples 1-9, above, the water pump is configured to pump water into the tubular member through the number of pipes, the first nozzle, and the second nozzle. The first aperture is substantially concentric with the tubular member and configured to drain at least a portion of the water out of the tubular member and through a thickness of the plate. The pumping and draining forms a water vortex within the tubular member, the water vortex having an axis substantially central to the tubular member and a maximum width, in a direction substantially parallel to the plate, of not less than forty percent and not greater than sixty percent of a maximum width of the tubular member.

The following portion of this paragraph delineates example 11 of the subject matter, disclosed herein. According to example 11, which encompasses any one of examples 1-10, above, the tubular member further includes an open side at a second tubular member end opposite to the first tubular member end. The portion of the water includes a first portion of the water. The water pump is configured to pump water such that a second portion of the water overflows out of the open side while maintaining the water vortex.

The following portion of this paragraph delineates example 12 of the subject matter, disclosed herein. According to example 12, which encompasses any one of examples 1-11, above, the apparatus includes a multitude of light sources angled toward the tubular member and fixedly coupled to the second side of the plate external to the tubular member. The multitude of light sources are arranged in a longitudinal shape, the longitudinal shape having a length of not less than 85 percent of a maximum width of the tubular member and not greater than 115 percent of the maximum width of the tubular member. The tubular member is substantially centered with respect to a length of the longitudinal member.

The following portion of this paragraph delineates example 13 of the subject matter, disclosed herein. According to example 13, which encompasses any one of examples 1-12, above, the first aperture has a maximum width, in a direction substantially parallel to the plate, of not less than 1 centimeter (“cm”) and not greater than 1.5 cm.

The following portion of this paragraph delineates example 14 of the subject matter, disclosed herein. According to example 14, which encompasses any one of examples 1-13, above, a length of the first first-nozzle portion, in a direction substantially perpendicular to the plate, is not greater than 10 percent of a length of the tubular member in the direction.

The following portion of this paragraph delineates example 15 of the subject matter, disclosed herein. According to example 15, a system includes an apparatus. The apparatus includes a plate. The plate includes a number of apertures extending from a first side of the plate to a second side of the plate opposite to the first side. The number of apertures include a first aperture substantially central to the plate and a subset of apertures. Each aperture of the subset of apertures has a width such that a maximum width of the first aperture is not less than thirty percent of the width of each aperture of the subset of apertures and not greater than sixty percent of the width of each aperture of the subset of apertures. The apparatus includes a tubular member fixedly coupled to the second side of the plate at a first tubular member end. The tubular member has a maximum width, in a direction substantially parallel to the plate, such that the maximum width of the first aperture is not less than 5 percent of the maximum width of the tubular member and not greater than 13 percent of the maximum width of the tubular member. The tubular member includes a perimeter surrounded by the subset of apertures and surrounding the first aperture. The apparatus includes a first nozzle. The first nozzle includes a first first-nozzle portion coupled to the second side of the plate at a first location and extending into the tubular member in a first direction substantially perpendicular to the plate. The first nozzle includes a second first-nozzle portion extending, from a first end coupled to the first first-nozzle portion to a second end opposite to the first end, in a second direction substantially perpendicular to the first direction. The apparatus includes a second nozzle. The second nozzle includes a first second-nozzle portion coupled to the second side of the plate at a second location and extending into the tubular member in a third direction substantially parallel to the first direction. A distance between each of the second location and the first aperture and the first location and the first aperture is less than 50 percent of the maximum width of the tubular member and not less than 35 percent of the maximum width of the tubular member. The second nozzle includes second second-nozzle portion extending, from a first end coupled to the first second-nozzle portion to a second end opposite to the first end, in a fourth direction substantially opposite to the first direction and substantially perpendicular to the third direction. The apparatus includes a number of pipes. The number of pipes includes a first pipe including a first first-pipe end coupled to the first first-nozzle portion and a second first-pipe end opposite to the first first-pipe end. The number of pipes includes a second pipe including a first second-pipe end coupled to the first second-nozzle portion and a second second-pipe end opposite to the first second-pipe end. A third pipe includes a first third-pipe end and a second third-pipe end. The apparatus includes a coupler. The coupler is configured to couple the third pipe to the first pipe and the second pipe. The coupler includes a first coupler portion coupled to the second first-pipe end, a second coupler portion coupled to the second second-pipe end and extending at a first angle with respect to the first coupler portion, and a third coupler portion coupled to the first third-pipe end. The third coupler portion extends at a second angle with respect to the second coupler portion and extends at a third angle with respect to the first coupler portion. The apparatus includes a water pump coupled to the second third-pipe end and configured to pump water into the third pipe and out of at least one of the first nozzle and the second nozzle at an hourly rate of not less than a product of 215 and a water volume of the tubular member and not greater than a product of 430 and a water volume of the tubular member. The system includes a tank. The tank includes a receptacle configured to removably receive the apparatus, a base located at a first end of the tank, and at least three sides. Each of the at least three sides are coupled to the base. The sides include a first side. The first side includes a depression extending through a thickness of the first side. The depression includes a curved edge. The tank includes a drain located on the first side and having a center point located a distance away from the base, in a direction substantially perpendicular to the base, that is no more than 10 percent of a length of the tank.

The following portion of this paragraph delineates example 16 of the subject matter, disclosed herein. According to example 16, which encompasses example 15, above, when the apparatus is received by the tank, a distance between a second end of the tank opposite to the first end and the first side of the plate is not less than 3.8 centimeters (“cm”) and not greater than 11.4 cm.

The following portion of this paragraph delineates example 17 of the subject matter, disclosed herein. According to example 17, which encompasses any one of examples 15-16, above, The system includes a ledge protruding into the receptacle and at least one support member. Each of the at least one support member is sized to be removably inserted into the tank and includes a first end configured to rest against the ledge. A quantity of the at least one support member is equal to a quantity of the at least three sides.

The following portion of this paragraph delineates example 18 of the subject matter, disclosed herein. According to example 18, which encompasses any one of examples 15-17, above, the system includes a sensor configured to determine a water level of the receptacle and a controller configured to actuate, based at least in part on the water level, turning off the water pump.

The following portion of this paragraph delineates example 19 of the subject matter, disclosed herein. According to example 19, which encompasses any one of examples 15-18, above, the water pump includes a cord configured to extend through a cord aperture formed by the first side of the tank and an indentation of an edge of the plate and to extend over the curved edge of the depression.

The following portion of this paragraph delineates example 20 of the subject matter, disclosed herein. According to example 20, a method includes inserting an apparatus into a receptacle of a tank. The apparatus includes a plate. The plate includes a number of apertures extending from a first side of the plate to a second side of the plate opposite to the first side. The number of apertures includes a first aperture and a subset of apertures. The apparatus includes a tubular member fixedly coupled to the second side of the plate at a first tubular member end. The tubular member has a perimeter surrounded by the subset of apertures and surrounding the first aperture. The apparatus includes a first nozzle. The first nozzle includes a first first-nozzle portion coupled to the second side of the plate at a first location and extending into the tubular member in a first direction substantially perpendicular to the plate and a second first-nozzle portion extending, from a first end coupled to the first first-nozzle portion to a second end opposite to the first end, in a second direction substantially perpendicular to the first direction. The apparatus includes a second nozzle. The second nozzle includes a first second-nozzle portion coupled to the second side of the plate at a second location and extending into the tubular member in a third direction substantially parallel to the first direction and a second second-nozzle portion extending, from a first end coupled to the first second-nozzle portion to a second end opposite to the first end, in a fourth direction substantially opposite to the second direction and substantially perpendicular to the third direction. The apparatus includes a number of pipes. The apparatus includes a water pump coupled to the number of pipes and configured to pump water through a pipe of the number of pipes and out of at least one of the first nozzle and the second nozzle. The method includes threading a cord coupled to the water pump through an aperture formed by a first side of the tank and an indentation in the plate and over a depression in the first side of the tank. The method includes pumping, via the water pump, water into a pipe of the number of pipes and out of the first nozzle and the second nozzle at an hourly rate of not less than a product of 215 and a water volume of the tubular member and not greater than a product of 430 and the water volume of the tubular member.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A is a perspective view of a system, according to one or more examples of the present disclosure;

FIG. 1B is a cross-sectional view of a system, according to one or more examples of the present disclosure;

FIG. 1C is a close-up, cross-sectional view of a system, according to one or more examples of the present disclosure;

FIG. 1D is a close-up view of a system, according to one or more examples of the present disclosure;

FIG. 1E is a top view of a system, according to one or more examples of the present disclosure;

FIG. 2 is a top view of a system maintaining a vortex, according to one or more examples of the present disclosure;

FIG. 3A is a top view of an apparatus, according to one or more examples of the present disclosure;

FIG. 3B is a perspective view of an apparatus, according to one or more examples of the present disclosure;

FIG. 3C is a bottom perspective view of an apparatus, according to one or more examples of the present disclosure;

FIG. 4 is a schematic diagram of a nozzle rotation apparatus, according to one or more examples of the present disclosure;

FIG. 5 is a schematic diagram of a water pump controller, according to one or more examples of the present disclosure; and

FIG. 6 is a schematic flow chart of a method, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Since ancient times, water has been a balancing element for the human body and soul. Water sounds can help to heal, promote peace, and benefit overall well-being. Water sounds can also be interpreted as a non-threatening sound. Water fountains and other features involving running water can be used in residential, commercial, recreational, and/or hospitality settings to enhance a visual appearance of an environment. Running water can also create a soothing background sound profile. However, running water that is too loud can be overpowering rather than soothing. Additionally, installing and maintaining a running water feature can be complex and time consuming. Such set-up and maintenance can be particularly difficult for water fountains that involve vortexes. As such, examples of the present disclosure include water flow apparatuses and systems that help to simplify setup and maintenance and/or provide running water features in a desirable volume range. Examples of the present disclosure also include water flow apparatuses and systems that help to create and maintain water vortexes.

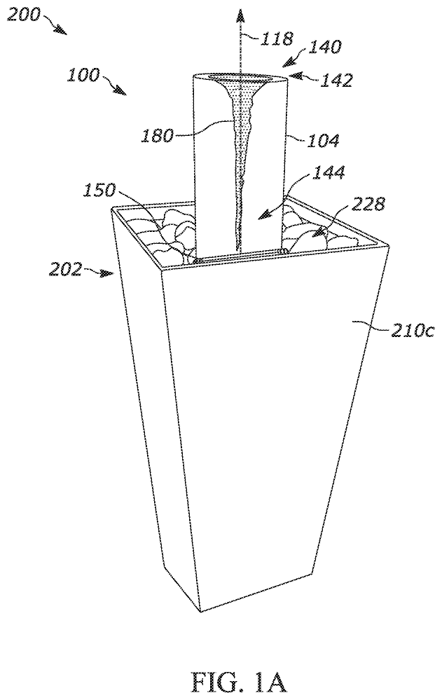

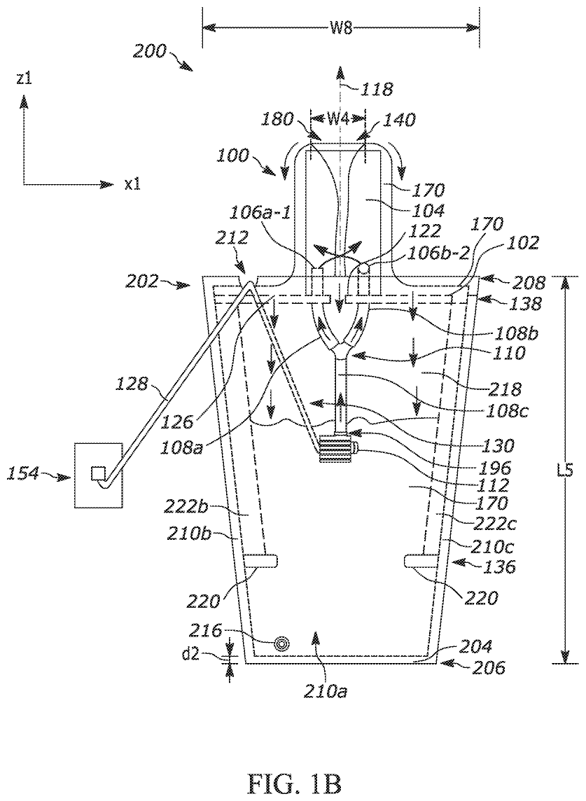

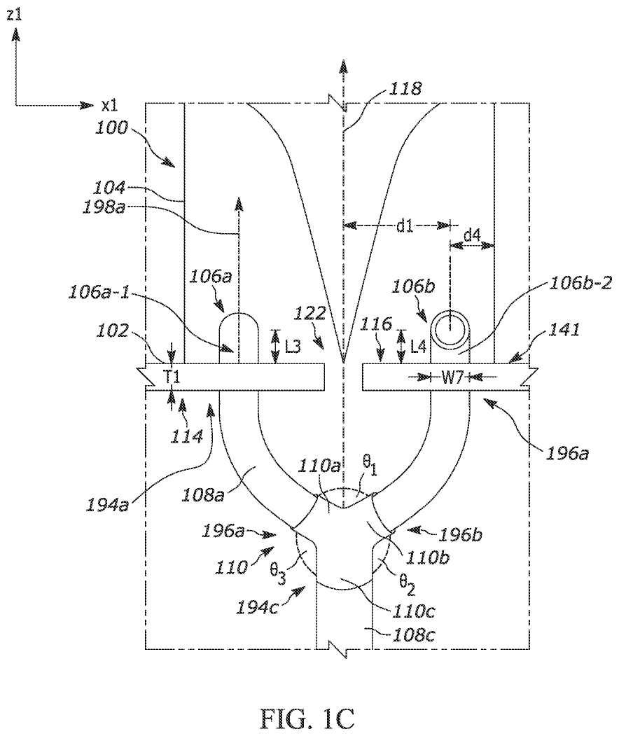

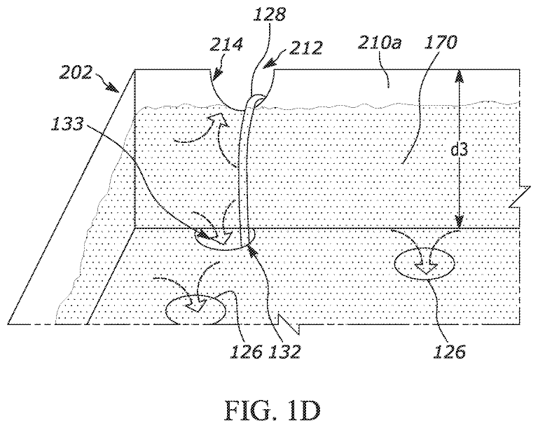

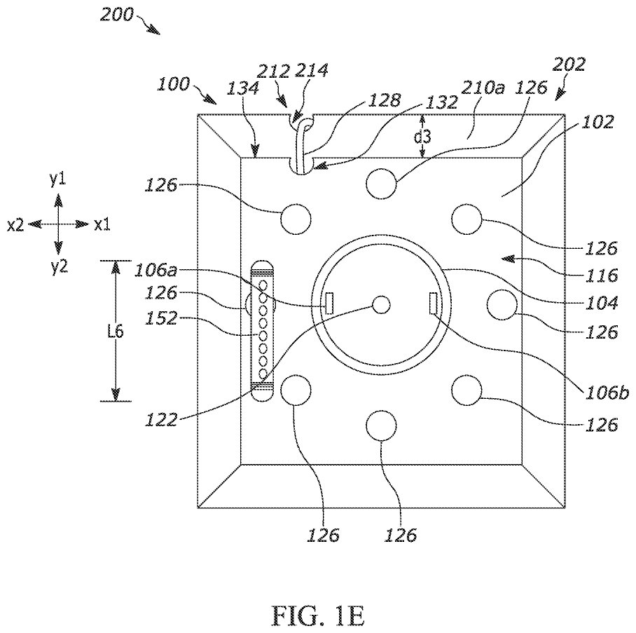

FIG. 1A is a perspective view of a system 100, according to one or more examples of the present disclosure. As shown in FIG. 1A, the system 100 includes an apparatus 101 configured to be received by a tank 103. In some examples, the apparatus 101 is configured to create differences in fluid velocities within a tubular member 104 such that water 170 overflows out of an open side 140 (e.g., an open top) of the tubular member 104 and forms a vortex 180. In some examples, the apparatus 101 is configured to maintain the vortex 180 without user input and/or manipulation. In some examples, the tank 103 receives the water 170 that overflows out of the tubular member 104 and/or is drained out of the tubular member 104, and the apparatus 101 pumps the water 170 back into the tubular member 104 such that the system 100 operates in a loop and the water 170 is re-used.

Although the term “water” is used herein to describe the fluid that is pumped into the tubular member 104 and creates a vortex 180, those of skill in the art will appreciate that examples of the present disclosure are not so limited. As used herein, “water” refers to any suitable fluid.

FIG. 1B is a cross-sectional view of the system 100, according to one or more examples of the present disclosure. As shown in FIG. 1B, the tank 103 receives the apparatus 101 such that a pump 112 of the apparatus is positioned within a receptacle 119 in an interior of the tank 103 and, when the receptacle 119 holds water 170, is configured to pump the water 170 into the tubular member to create a vortex 180 that is visible from an exterior of the tank 103. In some examples, the tank 103 includes a receptacle 119 configured to removably receive the apparatus 101. In some examples, the entire apparatus 101 is connected, such that a user may insert the apparatus 101 into the receptacle 119 with one motion.

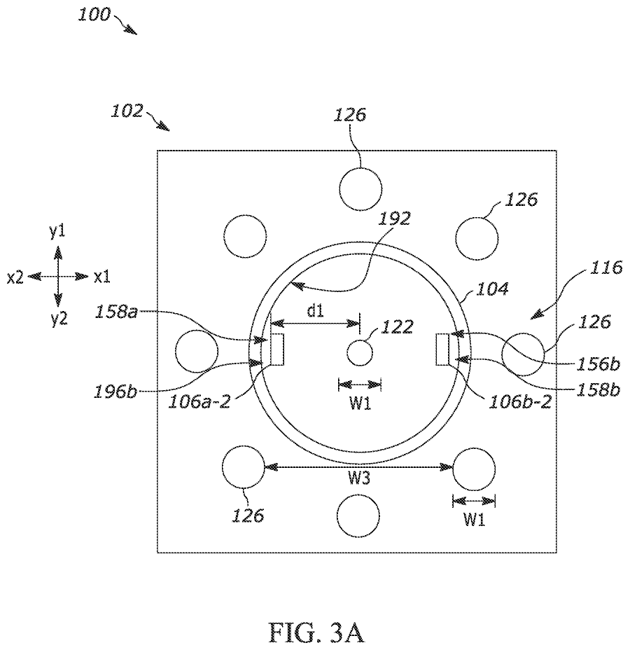

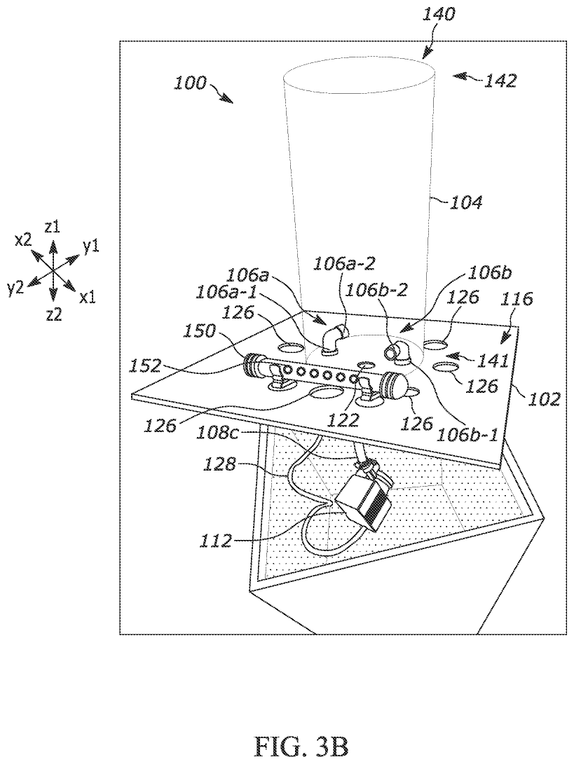

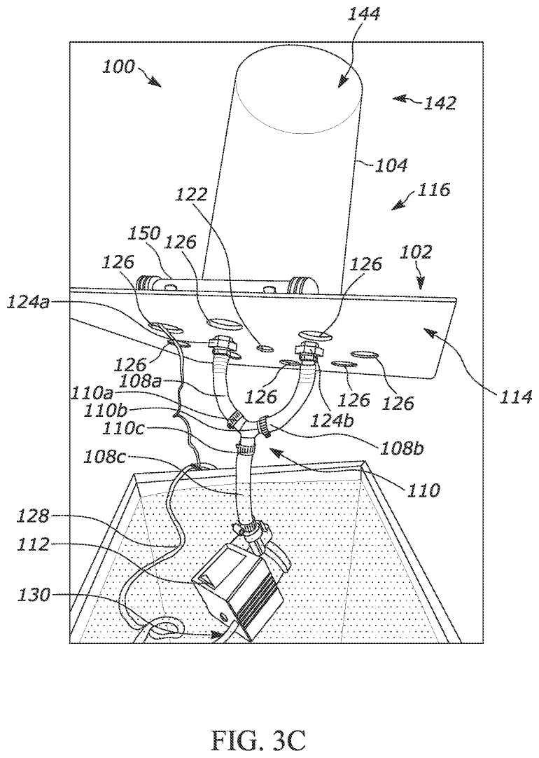

Referring to FIGS. 3A-C, the apparatus 101 includes a plate 102, a tubular member 104 fixed to the plate 102, a first nozzle 106a, a second nozzle 106b, a number of pipes 108a, . . . , 108c (referred to herein, individually and/or collectively, as “108”), and a water pump 112. In some examples, each of the tubular member 104, nozzles 106a, 106b, and pipes 108 are fixed to the plate 102, and the water pump 112 is fixed to at least one of the pipes 108. In such examples, the entire apparatus 101 can be lowered into the receptacle 119 and/or removed from the receptacle 119 in one motion.

As shown in FIG. 3A, in some examples, the plate 102 includes a number of apertures 122 and 126. As shown in FIG. 3C, in some examples, the plate 102 includes a first side 114 that is opposite to a second side 116.

In some examples, the plate 102 is rectangularly shaped. In some examples, the plate 102 is a square shape. In some examples, a shape of the plate 102 corresponds to a shape of an interior perimeter of the tank 103 (i.e., the outer perimeter of the receptacle 119).

Referring to FIG. 1C, in some examples, each of the apertures 122, 126 extend through a thickness T1 of the plate 102. In some examples, the thickness T1 of the plate 102 is from the first side 114 to the second side 116. As such, the apertures 122, 126 allow water 170 to flow from the second side 116 to the first side 114 and into the receptacle 119, as shown in FIG. 1B. In some examples, the thickness T1 of the plate 102 is not less than 1 cm and not greater than 10 cm.

In some examples, the plate 102 incudes a first aperture 122. In some examples, the first aperture 122 is substantially central to the plate 102. In some examples, the first aperture 122 has a central axis that is the same as and/or substantially aligned with a center point of the plate 102. As used herein, the term “substantially central to the plate” means that a distance, in a direction parallel to the plate 102, between the central axis of the first aperture 122 and the central axis of the plate 102 is less than five percent of a length of the plate 102 in the same direction. In some examples, the first aperture 122 is substantially concentric with the tubular member 104. In some examples, the first aperture 122 is also substantially concentric with a shape (e.g., a circle) formed by the arrangement of the subset of apertures 126.

As shown in FIG. 3A, in some examples, each of the apertures 126 and 122 are substantially circular in shape. However, examples of the present disclosure are not so limited. In some examples, one or more of the apertures 122 and/or 126 has a longitudinal shape, oval shape, rectangular shape, square shape, slot shape, and/or any combination thereof.

In some examples, the plate 102 includes a subset of apertures 126. In some examples, each aperture 126 of the subset has a maximum width W1. In some examples, the apertures 126 are substantially circular, and the maximum width W1 comprises a diameter of the aperture 126. In some examples, each of the apertures 126 have the same or similar maximum widths W1. In some examples, the maximum width W1 is in a direction substantially parallel to the plate 102. In some examples, the maximum width W1 is not less than 2.5 centimeters (“cm”) and not greater than 3.5 cm. In some examples, the maximum width W1 is substantially equal to:

$$W 1 = \frac{flow rate}{L 1 * W 3 * a} ,$$

where flow rate refers to the rate of the water pump 112 pumping the water 170 in gallons per hour, and a is approximately 0.32 gal/(hour*cm³).

In some examples, the first aperture 122 has a maximum width W2, in a direction parallel to the maximum width W1 of the subset of apertures 126. As shown in FIG. 1C, the first aperture 122 helps to create the vortex 180 by draining some of the water 170 from the tubular member 104. As such, in some examples, the vortex 180 has a central axis 118 that is substantially central to the first aperture 122. In some examples, as the water 170 flows, the central axis 118 moves in a radial direction around the central axis of the first aperture 122, with the central axis of the first aperture 122 serving as a center point for the radial movement.

In some examples, the maximum width W2 of the first aperture is less than the maximum width W1 the subset of apertures 126. In some examples, the maximum width W2 is not less than 30 percent and not greater than 60 percent of the maximum width W1. In some examples, the maximum width W1 is approximately 1.3 cm. In some examples, the maximum width W1 is not less than 1 cm and not greater than 1.5 cm.

Referring to FIGS. 1A-C and 3B-C, in some examples, the tubular member 104 extends in a direction substantially perpendicular to the plate 102. In some examples, the tubular member 104 is fixedly coupled to the second side 116 of the plate 102 at a first tubular member end 141 and has an open top 140 at a second end 142 that is opposite to the first end 141.

Referring to FIG. 3A, in some examples, the tubular member 104 is substantially cylindrical. In some examples, the tubular member 104 has a maximum width W3. In some examples, the maximum width W3 is in a direction substantially parallel to the plate 102. In some examples, the maximum width W2 of the first aperture 122 is not less than 5 percent of the maximum width W3 and not greater than 13 percent of the maximum width W3. In some examples, this relationship between the width W2 of the first aperture 122 and the width W3 of the tubular member 104 helps to maintain the vortex 180 continuously.

As shown in FIGS. 3A-C, in some examples, the tubular member 104 includes a perimeter that is surrounded by the subset of apertures 126 and surrounds the first aperture 122. In some examples, the subset of apertures 126 form a shape (e.g., a circle) that is substantially concentric with the tubular member 104. In some examples, the shape is substantially symmetrical with respect to the tubular member 104. In some examples, the subset of apertures 126 are spaced equidistant form each other. In some examples, the shape formed by the subset of apertures 126 is substantially symmetrical with respect to the axis 118.

In some examples, the apparatus 101 includes a number of nozzles 106a, 106b (referred to herein, individually and/or collectively, as “106”). In some examples, the nozzles 106 are fixed to the second side 116 of the plate 102 and surrounded by the tubular member 104. In some examples, the nozzles 106 are configured to allow water 170 to flow from the receptacle 119 and into the tubular member 104. In some examples, the nozzles 106 are positioned to allow the water 170 to flow into the tubular member 104 in a direction that is tangential to a hypothetical circle that is substantially concentric with the tubular member 104. In some examples, the flow of water 170 from the nozzles 106 helps to create the vortex 180 by creating differences in fluid velocity within the tubular member 104. In some examples, the flow of water 170 from the nozzles 106 also helps to maintain a supply of water 170 within the tubular member 104 for the vortex 180. In some examples, each nozzle 106 includes a nozzle outlet 199 from which the water 170 flows. In some examples, the nozzle outlet 199 has a width W7 of approximately 1.25 cm. In some examples, the nozzle width W7 is not less than 1 cm and not greater than 1.5 cm.

Referring to FIG. 3B, in some examples, each nozzle 106 is substantially L-shaped, or elbow-shaped. In some examples, a first nozzle 106a includes a first first-nozzle portion 106a-1 coupled to the second side 116 of the plate 102 at a first location and extending into the tubular member 104 in a first direction z/that is substantially perpendicular to the plate 102. As used herein, “substantially perpendicular to the plate” refers to an angle that is not less than 80 degrees and not greater than 100 degrees with respect to the plate 102. In some examples, the height of the first first-nozzle portion 106a-1 from the plate 102 in the first direction z/is not greater than 10 percent of the height of the tubular member 104 in the same direction. In some examples, the height of the first first-nozzle portion 106a-1 is not greater than 5 cm.

In some examples, the first nozzle 106a includes a second first-nozzle portion 106a-2 that extends, from a first end 156a coupled to the first first-nozzle portion 106a-1 to a second end 158a opposite to the first end 156a in a second direction y/substantially perpendicular to the first direction z1. In some examples, the second direction y/is substantially parallel to the plate 102.

In some examples, the apparatus 101 includes a second nozzle 106b. In some examples, the second nozzle 106b includes a first second-nozzle portion 106b-1 coupled to the second side 116 at a second location and extending into the tubular member 104 in a third direction z2 substantially parallel to the first direction z1. As used herein, “substantially parallel to” refers to within 10 degrees of the given direction.

In some examples, a distance d1 between each of the second location and the first aperture 122 and the first location and the first aperture 122 is less than 50 percent and not less than 35 percent of the tubular member 104's maximum width W3. In some examples, a minimum distance d4 between an interior surface 192 of the tubular member 104 and the first location and/or second location is not greater than 5 cm. In some examples, the minimum distance d4 is approximately 2.5 cm.

In some examples, the second nozzle 106b includes a second second-nozzle portion 106b-2 extending, from a first end 156b coupled to the first second-nozzle portion 106b-1 to a second end 158b opposite to the first end 106b-1, in a fourth direction y2 substantially opposite to the second direction y1 and substantially perpendicular to the third direction z2. As used herein, “substantially opposite” refers to a direction that is approximately 180 degrees from another given direction and/or not less than 170 degrees and not greater than 190 degrees from the given direction. As shown in FIG. 3A, in some examples, the first first-nozzle portion first end 156a is offset from the second second-nozzle portion's first end 156b in a direction y2. In some examples, the first first-nozzle portion 106a-1's first end 156a is substantially aligned, with the first second-nozzle portion 106b-1's second end 158b.

Referring to FIGS. 3C and 1B-C, in some examples, the apparatus 101 includes a number of pipes 108. In some examples, the pipes 108 are configured to allow water 170 to travel from the pump 112, through the pipes 108, and out of the nozzles 106. In some examples, pump 112 pushes the water 170 through the pipes 108, into the first first-nozzle portion 106a-1 and first second-nozzle portion 106b-1 and out of the second first-nozzle portion 106a-2 and the second second-nozzle portion 106b-2. As used herein, the term “pipe” may refer to tubing and/or pipes suitable for facilitating the travel of water, including tubing made of a flexible material.

In some examples, the apparatus 101 includes a water pump 112 coupled to the number of pipes 108. For example, as shown in FIG. 1B, the water pump 112 is coupled directly to the pipe 108c, and indirectly to the pipes 108a and 108b through the connection to the pipe 108c. In some examples, the water pump 112 includes a submersible pump, a centrifugal pump, a jet pump, a screw pump, a gear pump, a positive displacement pump, and/or any combination thereof.

In some examples, the water pump 112 is configured to pump water 170 into a pipe 108c of the number of pipes 108 at an hourly rate of not less than a product of 215 and a water volume of the tubular member 104 and not greater than a product of 430 and a water volume of the tubular member 104. As used herein, the term “water volume” refers to a maximum volume of water that could be held by the tubular member 104 without overflowing or draining (e.g., if the first aperture 122 were sealed). In some examples, the water volume can be described as follows:

Water Volume=Volume*264.172.

In some examples, the pump 112 is configured to pump water 170 at a rate of approximately 430 gallons per hour. In some examples, the tubular member 104 has a height L1 of approximately 30.5 cm. In some examples, the tubular member 104 has a maximum width W3 of approximately 15.2 cm and radius equal to half of the width W3, or approximately 7.6 cm. In such examples, the tubular member 104 has a substantially cylindrical shape, and the volume can be expressed as:

$$Volume = L 1 * {( \frac{W 3}{2} )}^{2} * π .$$

In such examples, the volume of the tubular member 104 is equal to approximately 0.00553 cubic meters, or approximately 5534.4.8 cubic cm. Since one cubic meter holds approximately 264.172 gallons of water, the water volume of the tubular member 104, in such examples, is equal to approximately 1.46 gallons. In some examples, the water volume of the tubular member 104 is approximately 1.46 gallons, and the water pump 112 is configured to pump water at a rate of 430 gallons per hour, or approximately 294 water volumes of the tubular member 104 per hour.

In some examples, a coupler 110 couples the number of pipes 108 to each other. In some examples, the coupler 110 is made of a rigid material, such as a metallic material. In some examples, the coupler 110 is a Y-shaped, female pipe connector. In some examples, the coupler 110 comprises a brass Y-fitting.

In some examples, the number of pipes 108 includes a first pipe 108a coupled to the first first-nozzle portion 106a-1 at a first end 194a. In some examples, the first pipe 108a includes a second end 196a opposite to the first end 194a that is coupled to the coupler 110. In some examples, the second end 196a is a male component of a male-female connection between the first pipe 108a and the coupler 110.

In some examples, the number of pipes 108 includes a second pipe 108b coupled to the first second-nozzle portion 106b-1 at a first end 194b in some examples, the second pipe 108b is coupled to the coupler 110 at a second end 196b opposite to the first end.

Referring to FIG. 1C, in some examples, a length L3 of the first first-nozzle portion 106a-1 and/or the first second-nozzle portion 106b-1 is not greater than 10 percent of a length L1 of the tubular member 104 in the same direction. In some examples, a distance L4 between the second side 116 and a location on the nozzle 106 out of which the water 170 is expelled is not greater than 8 percent of the length L1.

In some examples, the number of pipes 108 includes a third pipe 108c. In some examples, the third pipe 108c includes a first third-pipe end 194c and a second third-pipe end 196c opposite to the first third-pipe end 194c. In some examples, the third pipe 108c is connected to the coupler 110 at the first end 194c and to the pump 112 at the second end 196c and the pump 112 pumps water through the pipes by pumping the water 170 into the third pipe 108c. In some examples, after passing through the third pipe 108c, the water branches off into the first and second pipes 108a, 108b.

In some examples, the coupler 110 is configured to couple the third pipe 108c to the other pipes 108a, 108b. In some examples, the coupler 110 includes three coupler portions 110a, 110b, 110c. In some examples, the coupler portions 110a, 110b, 110c form a “Y” shape. In some examples the first coupler portion 110a is coupled to the second first-pipe end 196a. In some examples, the first coupler portion 110a fits around the second first-pipe end 196a. In some examples, the second coupler portion 110b is coupled to the second second-pipe end 196b and extends at a first angle θ₁ with respect to the first coupler portion 110a. In some examples, the third coupler portion 110c is coupled to the first third-pipe end 194c.

In some examples, the third coupler portion 110c extends at a second angle θ₂ with respect to the second coupler portion 110b and extends at a third angle θ₃ with respect to the first coupler portion 110a. In some examples, each of the angles θ₁, θ₂, and θ₃ is approximately 120 degrees. In some examples, the each of the angles θ₁, θ₂, and θ₃ are not less than 90 degrees and not greater than 130 degrees. In some examples, each angle θ₁, θ₂, and θ₃ is not more than 5 degrees less than or equal to another angle θ₁, θ₂, and θ₃.

In some examples, the tank 103 includes a base 105 located at a first end 107 of the tank 103. In some examples, the base 105 is substantially parallel to the plate 102 when the apparatus 101 is received by the tank 103. In some examples, the tank includes at least three sides 111a, . . . , 111n (referred to herein, individually and/or collectively, as “111”). In some examples, each of the at least three sides 111 is coupled to the base 105. In some examples, the base 105 is fixed to each of the sides 111. In some examples, the tank 103 is a monolithic construction.

FIG. 1D is a close-up view of the system 100, according to one or more examples of the present disclosure. Referring to FIG. 1D, in some examples, the base includes a first side 111a. In some examples, the first side 111a is shaped to allow debris and other non-liquid elements to be passively removed from the tank 103. In some examples, the first side 111a includes a depression 113 that extends through a thickness of the first side 111a. In some examples, the depression 113 includes a curved edge 115. In some examples, the curved edge 115 allows cords (e.g., cord 128) to rest against the side 111a.

In some examples, the water pump 112 is configured to be at least partially submerged in the water 170 in the receptacle 119. In some examples, the water pump 112 includes a cord 128 configured to connect the water pump 112 to a power source (e.g., to an outlet 154). In some examples, the cord 128 includes at least one water-proof fitting disposed about a circumference of at least a portion of the cord 128. Referring to FIG. 1D, in some examples, the cord 128 is configured to extend from below the plate 102 and through a cord aperture 133 formed by the indentation 132 and the side 111a.

Referring to FIGS. 1E and 1D, in some examples, the apparatus 101 is received by the tank 103, and a distance d3 between the second end 109 of the tank 103 and the second side 116 of the plate 102 is not less than 3.8 cm and not greater than 11.4 cm. In some examples, the distance d3 is not greater than 10 percent of the height L5 of the tank 103.

Referring to FIG. 1B, in some examples, the tank 103 includes one or more ledges 121 protruding into the receptacle 119. In some examples, the ledges 121 are positioned above the drain 117 but below the plate 102. In some examples, the ledges 121 are made of the same material as the sides 111. In some examples, the system 100 includes one or more support members 123b, 123c (referred to herein, individually and/or collectively, as “123”). In some examples, the one or more support members 123 are shaped to rest against the ledges 121 and support the plate 102 within the tank 103. In some examples, each of the support members 123 are of the same dimensions, such that the plate 102 is level with respect to the base 105. In some examples, the support members 123 are sized to be removably inserted into the tank 103. In some examples, the system 100 includes a level to indicate whether the plate 102 is horizontally level.

In some examples, the support members 123 include a first end 136 configured to rest against a ledge 121. In some examples, the first end 136 rests against the ledge such that the support member 123 is flush against a side 111 of the tank 103.

In some examples, the support member 123 includes a second end 138 opposite to the first end 136. In some examples, the apparatus 101 is received by the tank 103 via the plate 102 resting against the second end 138 of a number of support members 123.

In some examples, a quantity of the number of support members 123 is at least half of a quantity of the sides 111. In some examples, the quantity of the number of support members 123 is equal to the quantity of the sides 111. In some examples, the tank 103 includes four sides, and the system 100 includes four support members 123.

In some examples, the support members 123 are fixed to the sides 111. In some examples, the support members 123 are welded to the sides 111. In some examples, the tank does not include ledges 121, but the side 111 and the corresponding and the corresponding support member 123 are of a monolithic construction.

In some examples, the system 100 is configured to allow a user to drain water from the receptacle 119. In some examples, the tank 103 includes a drain 117. In some examples, the drain 117 is positioned on the first side 111a of the tank 103. In other examples, the drain 117 is positioned on another side 111 and/or on the base 105. In some examples, the drain 117 extends through a thickness of the tank 103. In some examples, the drain 117 is located a distance d2 away from the base 105. In some examples, the distance d2 is a distance between a center point of the drain 117 and the base 105. In some examples, the distance d2 is no more than 10 percent of a length L5 of the tank 103.

In some examples, the length L5 extends from the base 105 to the end 109. In some examples, the length L5 is approximately 75 cm. In some examples, the length L5 is not less than 60 cm and not greater than 80 cm. In some examples, the tank has a width W8 of approximately one third of the length L5. In some examples, the width W8 is not less than one quarter and not greater than one half of the length L5. In some examples, the sides 111 of the tank 103 are tapered.

In some examples, the tank is made of a lightweight material. In some examples, the tank 103 includes a coating that is made of a polypropylene material. In some examples, the tank 103 is made of a polypropylene material.

As shown in FIG. 1A, in some examples, the system 100 includes decorative material 129 configured to be placed on the plate 102 when the apparatus 101 is received by the tank 103. The decorative material 129 includes, for example, rocks, plants, flowers, soil, sand, artificial plants, and/or any combination thereof.

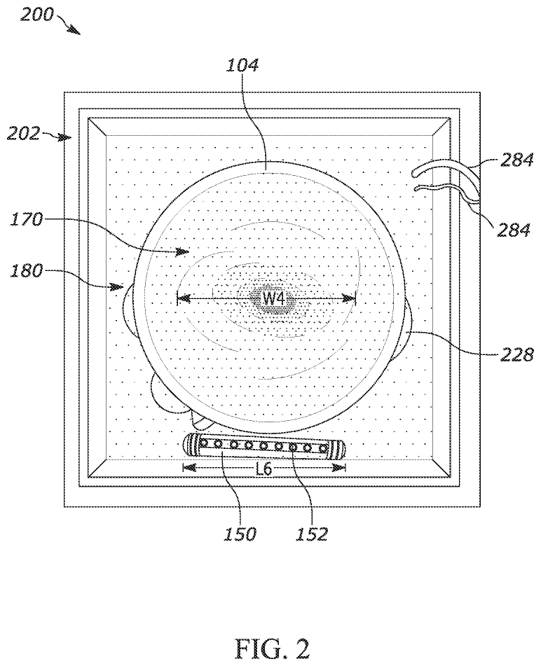

FIG. 2 is a top view of another embodiment of a system 100 for maintaining a vortex 180, according to one or more examples of the present disclosure. Referring to FIGS. 2 and 1B-C, in some examples, the water vortex 180 is formed by the differences in fluid velocities within the tubular member 104, caused by the pumping of water 170 through the nozzles 106 and draining out of the first aperture 122. In some examples, the vortex 180 has an axis 118 substantially concentric with the tubular member 104.

Referring to FIGS. 2 and 1B, in some examples, the vortex 180 has a maximum width W4, in a direction substantially parallel to the plate 102, that is not less than 40 percent and not greater than 60 percent of the maximum width W3 of the tubular member 104.

As shown in FIG. 1B, the system 100 is configured to continuously maintain the vortex 180 while a portion of the water 170 is drained out of the first aperture 122 and another portion of the water 170 overflows out of the open top 140, landing on the plate 102 and eventually draining through the apertures 126 and into the receptacle 119. In some examples, the system 100 is configured to pump water 170 from the water pump 112 at a rate such that the sound resulting from the water 170 hitting the plate 102 is audible but not overpowering. In some examples, the system 100 is configured to pump water 170 such that the water 170 hitting the plate 102 produces of a sound of not less than 50 decibels and not greater than 90 decibels.

Referring to FIGS. 1E and 3B-C, in some examples, the apparatus 101 includes one or more light sources 152 configured to illuminate the tubular member 104. In some examples, the tubular member 104 is made of material 144 that is translucent and/or transparent. In some examples, the material 144 is an acrylic material. In some examples, the light source 152 emit light that appears to illuminate the water 170 and/or is reflected off the material 144.

In some examples, the light sources 152 are light-emitting diodes (“LEDs”). In some examples, the light source 152 are ultraviolet (“UV”) light sources. In some examples, the light sources 152 are fixed to the second side of the plate 102. In some examples, the light sources 152 face and/or are angled towards the tubular member 104.

In some examples, the light sources 152 are arranged in a longitudinal shape 150 (e.g., a strip of lights). In some examples, the longitudinal shape has a length L6 of not less than 85 percent of the tubular member 104's maximum width W3 and not greater than 115 percent of the maximum width W3. In some examples, the tubular member 104 is substantially centered with respect to the longitudinal shape 150.

In some examples, the tubular member 104 and/or the water 170 reflects light emitted by the light sources 152. In some examples, the light sources 152 are configured to emit light having a wavelength of not less than 380 nanometers (“nm”) and not greater than 500 nm.

FIG. 2 is a top view of a system 200, according to one or more examples of the present disclosure. In some examples, the system 200 is an embodiment of the system 100. As shown in FIG. 2, in some examples, the system 200 includes a longitudinal shape 150 (e.g., a strip) of light sources 152. In some examples, a length L6 of the strip 150 is not less than 50 percent and not greater than 100 percent of the maximum width W4 of the vortex 180.

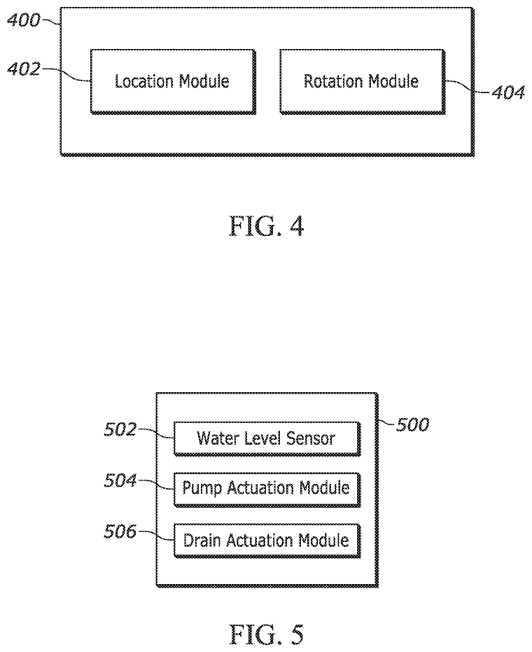

FIG. 4 is a schematic diagram of a nozzle rotation apparatus 400, according to one or more examples of the present disclosure. In some examples, the apparatus 101 and/or system 100 includes a controller, an embodiment of which is the nozzle rotation apparatus 400. In some examples, the nozzle rotation apparatus 400 includes a location module 402 and/or a rotation module 404.

In some examples, the location module 402 is configured to determine a geographic location of the apparatus 101. In some examples, the location module 402 is configured to determine a geographic location based at least in part on at least one of the following: user input (e.g., via a user interface), Global Positioning System (“GPS”), Wi-Fi connection, and/or any combination thereof.

In some examples, the location module 402 is configured to determine, based at least in part on the geographic location, a hemisphere of the geographic location. For example, the location module 402 determines a latitude and longitudinal location of the system 100 and determines whether the location is north or south of the equator.

In some examples, the rotation module 404 is configured to actuate, based at least in part on the determining, rotation of each of the first first-nozzle portion 106a-1 and the first second-nozzle portion 106b-1 about axes 198a, 198b (shown in FIG. 1C) substantially perpendicular to the plate 102 such that the second first-nozzle portion 106a-2 extends in the fourth direction y2 and the second second-nozzle portion 106b-2 extends in the first direction y1. In such examples, the nozzles 106 are rotatably coupled to the plate 102 (e.g., via a ball bearing, thrust bearing, swivel joint, slip ring, gear, and/or any combination thereof), and the pipes 108 are coupled to apertures in the plate 102 that are aligned with the nozzles 106.

FIG. 5 is a schematic diagram of a water pump controller 500, according to one or more examples of the present disclosure. In some examples, the water pump controller 500 is an embodiment of a controller of the water pump 112. In some examples, the water pump controller 500 is housed on the water pump 112.

As shown in FIG. 5, in some examples, the water pump controller 500 includes a water level sensor 502. In some examples, the water level sensor 502 is configured to determine a water level of a receptacle. In some examples, the water level sensor 502 includes: a tethered float switch, a pressure switch, and/or any combination thereof. In some examples, the sensor 502 is positioned exterior to the water pump 112.

In some examples, the controller 500 includes a pump actuation module 504. In some examples, the pump actuation module 504 is configured to actuate, based at least in part on the water level, turning off the water pump 112. In some examples, the pump actuation module 504 determines that the water 170 in the receptacle 119 is below a threshold and actuates turning off the water pump 112 in response.

In some examples, the controller 500 includes a drain actuation module 506. In some examples, the drain 117 includes a smart valve in communication with the drain actuation module 506. In some examples, the drain actuation module 506 is configured to actuate opening of the drain based at least in part on the water level. In some examples, the drain actuation module 506 is configured to actuate opening of the drain 117 in response to determining that the water level is above a threshold water level. In some examples, the drain actuation module 506 is configured to actuate opening of the drain 117 in response to input from a user and/or expiration of a timer. In some examples, user input is received via communication with a mobile device of the user (e.g., via an application) and/or via a control panel provided on the tank 103.

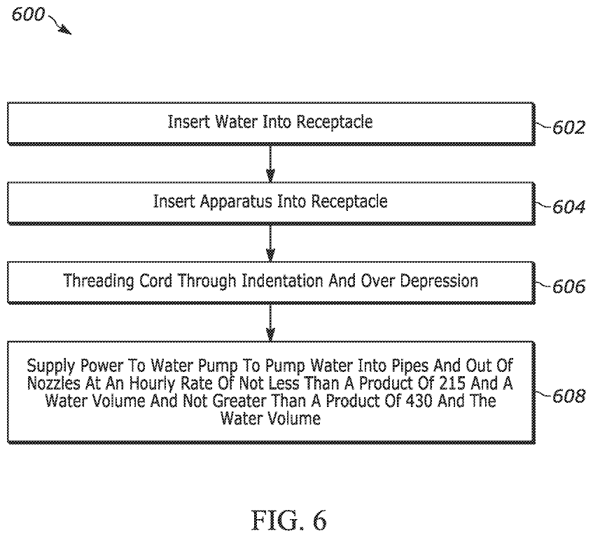

FIG. 6 is a schematic flow chart of a method 600, according to one or more examples of the present disclosure. In some examples, the method 600 includes inserting 602 water 170 into the receptacle 119 of the tank 103.

In some examples, the method 600 includes inserting 604 the apparatus 101 into the receptacle 119. In some examples, the method 600 includes first inserting the support members 123 into the receptacle 119 and resting them on the ledges 121. In some examples, inserting 604 the apparatus 101 into the receptacle 119 includes placing the plate 102 onto the support members 123. In some examples, inserting the apparatus 101 into the receptacle 119 includes inserting the apparatus 101 into the receptacle 119 such that the tubular member 104 extends beyond the end 109 of the tank 103. In some examples, the method 600 includes at least partially filling the receptacle 119 with water 170 prior to inserting the apparatus 101 into the receptacle 119.

In some examples, the method 600 includes threading 606 the cord 128 through the cord aperture 133 and over the depression 113 in the first side 111a. In some examples, the method 600 includes also threading a cord connecting the light sources 152 to a power source through the cord aperture 133 and over the depression 113.

In some examples, the method 600 includes pumping 608, via the water pump 112, water into the third pipe 108c, through the first pipe 608a and the second pipe 608b, and out of the first nozzle 106a and the second nozzle 106b at an hourly rate of not less than a product of 215 and a water volume of the tubular member 104 and not greater than a product of 430 and the water volume of the tubular member 104.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” in some embodiments, is defined to mean within +/−5% of a given value, however in additional embodiments any disclosure of “about” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An apparatus, comprising:
a plate, comprising a number of apertures extending from a first side of the plate to a second side of the plate opposite to the first side, the number of apertures comprising a first aperture and a subset of apertures;
a tubular member fixedly coupled to the second side of the plate at a first tubular member end, the tubular member having a perimeter surrounded by the subset of apertures and surrounding the first aperture;
a first nozzle, comprising:
a first first-nozzle portion coupled to the second side of the plate at a first location and extending into the tubular member in a first direction substantially perpendicular to the plate; and
a second first-nozzle portion extending, from a first end coupled to the first first-nozzle portion to a second end opposite to the first end, in a second direction substantially perpendicular to the first direction;
a second nozzle, comprising:
a first second-nozzle portion coupled to the second side of the plate at a second location and extending into the tubular member in a third direction substantially parallel to the first direction; and
a second second-nozzle portion extending, from a first end coupled to the first second-nozzle portion to a second end opposite to the first end, in a fourth direction substantially opposite to the second direction and substantially perpendicular to the third direction;
a number of pipes; and
a water pump coupled to the number of pipes and configured to pump water through a pipe of the number of pipes and out of the first nozzle and the second nozzle.

2. The apparatus of claim 1, each aperture of the subset of apertures having a width such that a maximum width of the first aperture is not less than thirty percent of the width of each aperture of the subset of apertures and not greater than sixty percent of a width of each aperture of the subset of apertures.

3. The apparatus of claim 2, the tubular member having a maximum width, in a direction substantially parallel to the plate, such that the maximum width of the first aperture is not less than 5 percent of the maximum width of the tubular member and not greater than 13 percent of the maximum width of the tubular member.

4. The apparatus of claim 3, wherein a distance between each of the second location and the first aperture and the first location and the first aperture is less than 50 percent of the maximum width of the tubular member and not less than 35 percent of the maximum width of the tubular member.

5. The apparatus of claim 1, wherein the pump is configured to pump the water at an hourly rate of not less than a product of 215 and a water volume of the tubular member and not greater than a product of 430 and a water volume of the tubular member.

6. The apparatus of claim 5, wherein the water volume comprises a product of a volume of the tubular member, in cubic meters, and 264.172 gallons.

7. The apparatus of claim 1, the number of pipes comprising:
a first pipe comprising a first first-pipe end coupled to the first first-nozzle portion and a second first-pipe end opposite to the first first-pipe end;
a second pipe comprising a first second-pipe end coupled to the first second-nozzle portion and a second second-pipe end opposite to the first second-pipe end; and
a third pipe comprising a first third-pipe end and a second third-pipe end, wherein the pipe comprises the third pipe.

8. The apparatus of claim 7, further comprising a coupler, the coupler configured to couple the third pipe to the first pipe and the second pipe, the coupler comprising:
a first coupler portion coupled to the second first-pipe end;
a second coupler portion coupled to the second second-pipe end and extending at a first angle with respect to the first coupler portion; and
a third coupler portion coupled to the first third-pipe end, the third coupler portion extending at a second angle with respect to the second coupler portion and extending at a third angle with respect to the first coupler portion.

9. The apparatus of claim 8, wherein:
the first angle is not less than 90 degrees and not greater than 130 degrees;
the second angle is not less than 90 degrees and not greater than 130 degrees; and
the third angle is not more than 5 degrees greater than and not more than 5 degrees less than the second angle.

10. The apparatus of claim 1, wherein:
the water pump is configured to pump water into the tubular member through the number of pipes, the first nozzle, and the second nozzle;
the first aperture is substantially concentric with the tubular member and configured to drain at least a portion of the water out of the tubular member and through a thickness of the plate; and
the pumping and draining forms a water vortex within the tubular member, the water vortex having an axis substantially central to the tubular member and a maximum width, in a direction substantially parallel to the plate, of not less than forty percent and not greater than sixty percent of a maximum width of the tubular member.

11. The apparatus of claim 10, wherein:
the tubular member further comprises an open side at a second tubular member end opposite to the first tubular member end;
the portion of the water comprises a first portion of the water; and
the water pump is configured to pump water such that a second portion of the water overflows out of the open side while maintaining the water vortex.

12. The apparatus of claim 1, further comprising a multitude of light sources angled toward the tubular member and fixedly coupled to the second side of the plate external to the tubular member, wherein:
the multitude of light sources are arranged in a longitudinal shape, the longitudinal shape having a length of not less than 85 percent of a maximum width of the tubular member and not greater than 115 percent of the maximum width of the tubular member; and
the tubular member is substantially centered with respect to a length of the longitudinal shape.

13. The apparatus of claim 1, the first aperture having a maximum width, in a direction substantially parallel to the plate, of not less than 1 centimeter (“cm”) and not greater than 1.5 cm.

14. The apparatus of claim 1, wherein a length of the first first-nozzle portion, in a direction substantially perpendicular to the plate, is not greater than 10 percent of a length of the tubular member in the direction.

15. A system, comprising:
an apparatus, comprising:
a plate comprising a number of apertures extending from a first side of the plate to a second side of the plate opposite to the first side, the number of apertures comprising a first aperture substantially central to the plate and a subset of apertures, each aperture of the subset of apertures having a width such that a maximum width of the first aperture is not less than thirty percent of the width of each aperture of the subset of apertures and not greater than sixty percent of the width of each aperture of the subset of apertures;
a tubular member fixedly coupled to the second side of the plate at a first tubular member end, the tubular member having:
a maximum width, in a direction substantially parallel to the plate, such that the maximum width of the first aperture is not less than 5 percent of the maximum width of the tubular member and not greater than 13 percent of the maximum width of the tubular member; and
a perimeter surrounded by the subset of apertures and surrounding the first aperture;
a first nozzle, comprising:
a first first-nozzle portion coupled to the second side of the plate at a first location and extending into the tubular member in a first direction substantially perpendicular to the plate; and
a second first-nozzle portion extending, from a first end coupled to the first first-nozzle portion to a second end opposite to the first end, in a second direction substantially perpendicular to the first direction;
a second nozzle, comprising:
a first second-nozzle portion coupled to the second side of the plate at a second location and extending into the tubular member in a third direction substantially parallel to the first direction, wherein a distance between each of the second location and the first aperture and the first location and the first aperture is less than 50 percent of the maximum width of the tubular member and not less than 35 percent of the maximum width of the tubular member; and
a second second-nozzle portion extending, from a first end coupled to the first second-nozzle portion to a second end opposite to the first end, in a fourth direction substantially opposite to the first direction and substantially perpendicular to the third direction;
a number of pipes, comprising:
a first pipe comprising a first first-pipe end coupled to the first first-nozzle portion and a second first-pipe end opposite to the first first-pipe end;
a second pipe comprising a first second-pipe end coupled to the first second-nozzle portion and a second second-pipe end opposite to the first second-pipe end;
a third pipe comprising a first third-pipe end and a second third-pipe end;
a coupler, the coupler configured to couple the third pipe to the first pipe and the second pipe, the coupler comprising:
a first coupler portion coupled to the second first-pipe end;
a second coupler portion coupled to the second second-pipe end and extending at a first angle with respect to the first coupler portion; and
a third coupler portion coupled to the first third-pipe end, the third coupler portion extending at a second angle with respect to the second coupler portion and extending at a third angle with respect to the first coupler portion; and
a water pump coupled to the second third-pipe end and configured to pump water into the third pipe and out of at least one of the first nozzle and the second nozzle at an hourly rate of not less than a product of 215 and a water volume of the tubular member and not greater than a product of 430 and a water volume of the tubular member; and
a tank, comprising:
a receptacle configured to removably receive the apparatus;
a base located at a first end of the tank;
at least three sides, each of the at least three sides coupled to the base and comprising a first side, the first side comprising a depression, the depression extending through a thickness of the first side and comprising a curved edge; and
a drain located on the first side and having a center point located a distance away from the base, in a direction substantially perpendicular to the base, that is no more than 10 percent of a length of the tank.

16. The system of claim 15, wherein, when the apparatus is received by the tank, a distance between a second end of the tank opposite to the first end and the first side of the plate is not less than 3.8 centimeters (“cm”) and not greater than 11.4 cm.

17. The system of claim 15, further comprising:
a ledge protruding into the receptacle; and
at least one support member, each of at least one support member sized to be removably inserted into the tank and comprising a first end configured to rest against the ledge, wherein a quantity of the at least one support member is equal to a quantity of the at least three sides.

18. The system of claim 15, further comprising:
a sensor configured to determine a water level of the receptacle; and
a controller configured to actuate, based at least in part on the water level, turning off the water pump.

19. The system of claim 15, wherein the water pump comprises a cord configured to extend through a cord aperture formed by the first side of the tank and an indentation of an edge of the plate and to extend over the curved edge of the depression.

20. A method, comprising:
inserting an apparatus into a receptacle of a tank, wherein the apparatus comprises:
a plate, comprising a number of apertures extending from a first side of the plate to a second side of the plate opposite to the first side, the number of apertures comprising a first aperture and a subset of apertures;
a tubular member fixedly coupled to the second side of the plate at a first tubular member end, the tubular member having a perimeter surrounded by the subset of apertures and surrounding the first aperture;
a first nozzle, comprising:
a first first-nozzle portion coupled to the second side of the plate at a first location and extending into the tubular member in a first direction substantially perpendicular to the plate; and
a second first-nozzle portion extending, from a first end coupled to the first first-nozzle portion to a second end opposite to the first end, in a second direction substantially perpendicular to the first direction;
a second nozzle, comprising:
a first second-nozzle portion coupled to the second side of the plate at a second location and extending into the tubular member in a third direction substantially parallel to the first direction; and
a second second-nozzle portion extending, from a first end coupled to the first second-nozzle portion to a second end opposite to the first end, in a fourth direction substantially opposite to the second direction and substantially perpendicular to the third direction;
a number of pipes; and
a water pump coupled to the number of pipes;
threading a cord coupled to the water pump through an aperture formed by a first side of the tank and an indentation in the plate and over a depression in the first side of the tank; and
pumping, via the water pump, water from the receptacle, through a pipe of the number of pipes, and out of the first nozzle and the second nozzle at an hourly rate of not less than a product of 215 and a water volume of the tubular member and not greater than a product of 430 and the water volume of the tubular member.
